(19) United States
(12) Patent Application Publication
(10) Pub. No.: US 2011/0279757 A1
(43) Pub. Date: Nov. 17, 2011

(54) DISPLAY DEVICE

(75) Inventor: Nobuaki Yamada, Osaka (JP)

(73) Assignee: SHARP KABUSHIKI KAISHA, Osaka-shi, Osaka (JP)

(21) Appl. No.: 13/138,254

(22) PCT Filed: Sep. 25, 2009
(86) PCT No.: PCT/JP2009/066666

§ 371 Date: Jul. 25, 2011

(30) Foreign Application Priority Data
Feb. 13, 2009 (JP) 2009-031599

(51) Int. Cl. G02F 1/1335; H01J 1/62; G02B 5/30

(52) U.S. Cl. 349/96; 359/488.01; 313/504

(57) ABSTRACT

The present invention provides a display device having excellently well-designed appearance, which is characterized in that the region where the display panel disposed is hardly visible when the display is off, and an image looks as if it is popping out on the protective plate when the display is on. In at least one example embodiment, the present invention is a display device, including: a display panel; and a protective plate disposed at an observation surface side of the display panel, wherein the display device further comprises a light-transmitting portion at an observation surface side of the display panel, and the protective plate includes, when observed from a normal line direction of its main surface, a circularly polarizing plate which covers both of the light-transmitting portion and a region around the light-transmitting portion.

### TECHNICAL FIELD

The present invention relates to a display device. More specifically, the present invention relates to a display device equipped with a protective plate for protecting a display panel.

### BACKGROUND ART

Today, display devices which have a structure including a display panel for displaying images, a protective plate for protecting the display panel from external impact, dust, or the like, and a circularly polarizing plate having a light-reducing effect are known (see, for example, Patent Documents 1 to 4) as a display device such as a display for TVs or personal computers and a display for mobile units. The circularly polarizing plate is mounted on a display panel in Patent Document 1, and is mounted on a region corresponding to a display panel of a protective plate in Patent Documents 2 to 4.

The protective plate is generally formed to have the same size or a slightly larger size of the display panel as described in Patent Documents 2 to 4. However, protective plates formed to have a size much larger than that of the display panel are also proposed as described in Patent Document 1. These protective plates are normally located at an outermost layer at an observation surface side of the display panel, so that the protective plate configures a part of appearance of the display device. For this reason, these days the protective film has been desired not only to protect the display panel but also to have an excellently well-designed appearance.
[Patent Document 1] Japanese Kokai Publication No. 2008-139497
[Patent Document 2] Japanese Kokai Publication No. 2003-91244
[Patent Document 3] Japanese Kokai Publication NO. 2002-148592
[Patent Document 4] Japanese Kokai Publication No. 2002-72214

### SUMMARY OF THE INVENTION

### Problems to be Solved by the Invention

Patent Document 1 discloses, for satisfying the foregoing demands, a structure in which a circularly polarizing plate is mounted on a surface of the display panel, and further a protective plate including a smoke panel and a linearly polarizing plate is provided. However, in the display device having the aforementioned structure, the smoke panel used reduces the display transmittance itself and thus affects the display properties. Moreover, since the smoke panel used limits the appearance of the display device in terms of burnish or the like, the designs of the display device can further be improved.

The present invention has been created in consideration of the current situation mentioned earlier, and aims to provide a display device with an excellently-designed appearance, in which the display panel is hardly visible when the display is off, and a display condition with an image looking as if it is popping out on the protective plate can be observed when the display is on.

### Means for Solving the Problem

The present inventors made various investigations on display devices in which a display panel is hardly visible when the display is off. As a result, they first paid attention to the point that, in the current optical design, both of a light-transmitting portion for displaying images and a region around the portion, including the border therebetween, are clearly visible from a normal line direction of the main surface of the protective plate due to the difference in light amount between them when the display is off. The present inventors have found that the difference in the light amount is derived from the difference in the reflectance of external light. They also have found that equalizing the reflectance in the light-transmitting portion with the reflectance is generally difficult due to the members to be provided in the region around the light-transmitting portion, such as a light-absorbing member and a reflector. Taking the above findings into consideration, the present inventors then found that, by providing a circularly polarizing plate covering both of the light-transmitting portion and the region around the portion on the protective plate, outgoing of the reflection of the external light from inside the display device can be suppressed, and thereby the reflectances of the external lights of the respective light-transmitting portion and the region around the portion on the surface of the protective plate can be made uniform. As a result, the present inventors found it possible to achieve a display device with an excellently-designed good appearance in which the display panel is hardly visible when the display is off, and the display condition with an image alone looking as if it is popping out can be observed when the display is on. Accordingly, the present inventors have solved the above problems and completed the present invention.

Namely, the present invention relates to a display device, including: a display panel; and a protective plate disposed at an observation surface side of the display panel, wherein the display device further comprises a light-transmitting portion at an observation surface side of the display panel, and the protective plate includes, when observed from a normal line direction of its main surface, a circularly polarizing plate which covers both of the light-transmitting portion and a region around the light-transmitting portion.

In the display device of the present invention, examples of the display panel include liquid crystal panels, organic EL panels, Plasma Display Panels (hereinafter, referred to as PDP), and Field Emission Display Panels (hereinafter, referred to as FEDP).

In the display device of the present invention, a protective plate is disposed at an observation surface side of the display panel. One example of the display device having this structure is a display device in which a display panel is housed in a casing, and the display panel and the casing is covered by a protective plate. Generally, members other than the display panel, such as a backlight serving as a light source and a driver for driving the display panel are also housed in the casing. The shape, material, strength, and the like of the casing are not particularly limited, and are appropriately selected based on the shape, purpose of use, and the like of the display panel.

The light-transmitting portion disposed at an observation surface side of the display device is for allowing images displayed by the display panel to be observed from the observation surface side. The light-transmitting portion may be an opening or may be a portion formed of a transparent material. Examples of the light-transmitting portion include an opening part of the shading member, and a member formed of a transparent material.

The protective plate is a substrate provided to protect the display panel from dust and/or impact, and is disposed at an observation surface side of the display panel. The protective plate has a circularly polarizing plate which, seen from a normal line direction of the main surface, covers an area including a light-transmitting portion and a region therearound. The location to mount the circularly polarizing plate is not particularly limited, and may be on the main surface on the display panel side or on the main surface on the observation surface side of the protective plate. The circularly polarizing plate generally has a structure formed of a combination of a linearly polarizing plate (polarizer) for separating linearly polarized light from unpolarized light and, for example, a λ/4 retardation plate for converting the linearly polarized light to circularly polarized light. Alternatively, the polarizer may be mounted on the main surface on the observation surface side of the protective plate, and the λ/4 retardation plate may be mounted on the main surface on the display panel side of the protective plate.

According to the present invention, the protective plate provided with the circularly polarized plate which covers the area including the light-transmitting portion and the region therearound can equalize the reflectance of external light in the light-transmitting portion with that of the region around the light-transmitting portion on the surface of the protective film. The reason is described in detail below.

In the case where the circularly polarized plate is provided, for example, on the main surface on a display panel side of the protective plate, external light coming into the protective plate is converted into linearly polarized light by the polarizer and is then converted into circularly polarized light upon passing through the λ/4 retardation plate. The converted circularly polarized light hits and is reflected on the display panel in the light-transmitting portion, or hits and is reflected on a certain member in the region around the light-transmitting portion. Meanwhile, in the case where a light absorber is provided in the region around the light-transmitting portion, although the majority of light hitting the absorber is absorbed by the absorber, a little amount of light is reflected on the absorber.

The light that has hit and has been reflected on the display panel or the like turns into reverse circularly polarized light. The reverse circularly polarized light is converted into linearly polarized light by a λ/4 retardation plate and is then absorbed by a polarizer. Thus, almost none of the reflected light goes outside of the protective plate, resulting in reduction in the influence of the light from inside the display device at the surface of the protective plate. Accordingly, when the display is off, the reflectance of the external light at the light-transmitting portion can be made equal to the reflectance of the external light at the region around the light-transmitting portion on the protective plate so that the light-transmitting portion and the region therearound look uniform. As a result, the display panel is hardly visible. Meanwhile, when the display is on, an image looks as if it is popping out on the protective plate from the non-display state where the light-transmitting portion and the region therearound look uniform. Accordingly, a display device with an excellently-designed good appearance can be obtained. The effect mentioned above can also be obtained as well when the circularly polarized plate is mounted on the observation surface side of the protective plate and when the circularly polarized plate is provided separately, with the λ/4 retardation plate disposed on the display panel side and the polarizer disposed on the observation surface side.

In the display device having the aforementioned structure, for making the display panel more invisible when the display is off, the protective plate preferably has a structure in which, seen from a normal line direction of the main surface, the reflectance of external light at the surface corresponding to the light-transmitting portion is substantially equal to the reflectance of external light at the surface corresponding to the region around the light-transmitting portion.

In addition to the reflectance, if the surface corresponding to the light-transmitting portion and the surface corresponding to the region around the light-transmitting portion have substantially the same reflection chromaticity with one another, the display panel becomes more invisible and is therefore preferable. The reflection chromaticity can be measured with, for example, a spectrophotometer.

As the circularly polarized plate, in order to suppress coloring of reflected light, a so-called reverse wavelength-type retardation plate having larger retardation with longer wavelength light can be employed. In this case, retardation of the retardation plate becomes larger in accordance with each of the wavelengths of the incident light, so that λ/4 conditions can be adjusted depending on the wavelengths. If reflected light needs to be colored for the design of the display device, each wavelength is deviated from the λ/4 condition by allowing light with a longer wavelength to give a larger retardation, and thereby coloring of the light can be purposely achieved. For example, when the retardation value in the green region is reduced by about 50 to 80 nm from the optimum value (138 nm to light with a wavelength of 550 nm) by using a retardation plate with a constant retardation, such as a retardation plate including a cycloolefin polymer resin film (produced by Zeon Corporation, product name “ZEONOR”), the λ/4 condition for the near blue region is satisfied, while deviating from the λ/4 conditions in the green and red regions. Thus, reflection in the green and red regions increases. As a result, the reflected color is shifted to the yellow region. Therefore, it is possible to set the state where, when the display is on, an image looks as if it is popping out of a background that is in a yellow tone as a whole. In the case of the foregoing structure, however, leakage of the reflected light in the near green color, that occupies the largest portion of the natural light, occurs, thereby reducing the effect that the display panel is hardly recognizable when the display is off. It is to be noted that the color tone is not particularly limited. The color tone can be appropriately adjusted by controlling the wavelength dispersion properties of the retardation plate and the width of the retardation.

In the display device according to the present invention, the existence of the circularly polarized plate provided around the light-transmitting portion of the protective plate can be easily checked by measuring the phase difference with, for example, a phase difference-measuring device.

According to the present invention, the phrase “the circularly polarized plate covers both of the light-transmitting portion and the region around the light-transmitting portion” means the following: The circularly polarized plate not necessarily covers the entire region around the light-transmitting portion. Also, the region for disposing the circularly polarized plate can be determined depending on the conditions such as the design given to the protective plate and the shape of the casing, as long as the conditions are within the scope capable of exerting the effects of the present invention. Further, the protective plate may have a region where the circularly polarized plate does not exist thereon.

A preferable embodiment of the display device according to the present invention includes an embodiment in which the protective plate includes a transparent member, and the display device further includes a shading member in the region around the light-transmitting portion. This embodiment can avoid a scatter component disturbing the circularly polarization, such as a light absorber and a reflector, to be disposed around the display panel. As a result, the display panel is more invisible when the display is off.

Examples of the transparent member to be used as the protective plate include resin plates containing an acrylic resin, a polycarbonate resin or the like, and glass substrates. The protective plate may be colorless or colored. In the case of a colorless protective plate, the display device can display images in the same color tones as those shown on the display panel. In contrast, in the case of a colored protective plate, the display device can display images shown on the display panel in a modified color tone, for example in a blue tone, red tone, or the like.

The thickness of the protective plate is not particularly limited. The protective plate preferably has a thickness capable of maintaining the strength that is needed as a protective plate, based on the strength of the display panel to protect.

The shape of the protective plate seen from the normal line direction is not particularly limited, and may be an elliptical shape, a rectangular shape with rounded corners, a combination of a rectangular shape and an elliptical shape as well as a rectangular shape.

The surfaces of the protective plate may be provided with a surface treatment, such as hard coating.

Examples of the shading member include materials containing black absorbers. The display device having the shading member can keep members disposed around the display panel, such as a driver and a wiring, out of sight when seen from the observation surface side, and thus has an excellently well-designed appearance. Furthermore, when the display is off, the display panel is hardly visible from observers with the entire surface of the protective plate turned black, and when the display is on, images look as if they are popping out of the black background. As a result, in the case where the display device is used for mobile units such as mobile phones and mobile gaming devices, the mobile units can have well-designed and stylish appearance. In the case where the display device is used for TV sets or displays for personal computers, they can have well-designed appearance suitable for interior items.

If the protective plate further has an antireflection film having a nano structure formed thereon on the main surface of the protective plate on the side opposite to the side where the display panel is provided, reflection of light on the surface of the protective plate can be suppressed. The nano structure refers to concave portions each with a depth of 1 nm or more and less than 1 μm (=1000 nm) and/or convex portions each with a height of 1 nm or more and less than 1 μm (=1000 nm). Examples of the nano structure include a moth-eye structure.

Examples of the preferable embodiment of the display device according to the present invention include an embodiment in which a gap between the display panel and the protective plate is filled with a resin. When foreign substances enter the gap between the display panel and the protective plate, the foreign substances disturb the polarized state, and as a result, the display panel sometimes looks luminous when the display is on. It is possible to avoid entering of the foreign substances by filling the gap between the display panel and the protective plate with the resin.

The resin to be injected is preferably a transparent resin so as not to reduce the transmittance. The haze level of the resin is preferably at most 1%, and more preferably at most 0.1%. The kinds of the resin are not particularly limited, and examples of the resin include thermosetting resins and photocurable resins. Examples of the thermosetting resins include acrylic resins, urethane acrylic resins, and epoxy resins. Examples of the photocurable resins include UV light curable resins, and visible light curable resin. The refractive index of optical members to be used for the display panel is normally approximately 1.5. Therefore, acrylic photocurable resins are preferably used for reducing the difference in the refractive index.

The display panel is preferably a liquid crystal panel. The liquid crystal panel has a structure in which a liquid crystal layer is interposed between a pair of substrates, and normally, a polarizing plate is mounted at least on the observation surface side of the liquid crystal panel. In the present invention, the circularly polarizing plate provided on the protective plate can be used as the polarizing plate provided on the observation surface side of the liquid crystal panel. A polarizing plate is thus not necessarily provided on the observation surface side of the liquid crystal panel, and the number of the polarizing plate to be used in the device as a whole can be reduced, thereby achieving cost reduction.

The display panel may be an organic eletroluminescence display panel.

### Effects of the Invention

The display device of the present invention can provide a display device having excellently well-designed appearance, which is characterized in that the display panel is hardly visible when the display is off, and an image looks as if it is popping out on the protective plate when the display is on.

### BRIEF DESCRIPTION OF THE DRAWINGS

FIG. 1 is a cross-sectional view schematically illustrating the structure of a display device according to Embodiment 1 of the present invention.

FIG. 2 is a plain view schematically illustrating the display device, seen from a normal line direction to the surface of the substrate, according to Embodiment 1 of the present invention. FIG. 2(a) illustrates the state when the display is on, and FIG. 2(b) illustrates the state when the display is off.

FIG. 3 is a cross-sectional view schematically illustrating the structure of the display device according to Embodiment 2 of the present invention.

FIG. 4 is a cross-sectional view schematically illustrating the structure of the display device according to Embodiment 3 of the present invention.

FIG. 5 is a cross-sectional view schematically illustrating the structure of the display device according to comparative embodiment of the present invention.

FIG. 6 is a plain view schematically illustrating the display device, seen from a normal line direction to the surface of the substrate, according to comparative embodiment of the present invention. FIG. 6(a) illustrates the state when the display is on, and FIG. 6(b) illustrates the state when the display is off.

### MODES FOR CARRYING OUT THE INVENTION

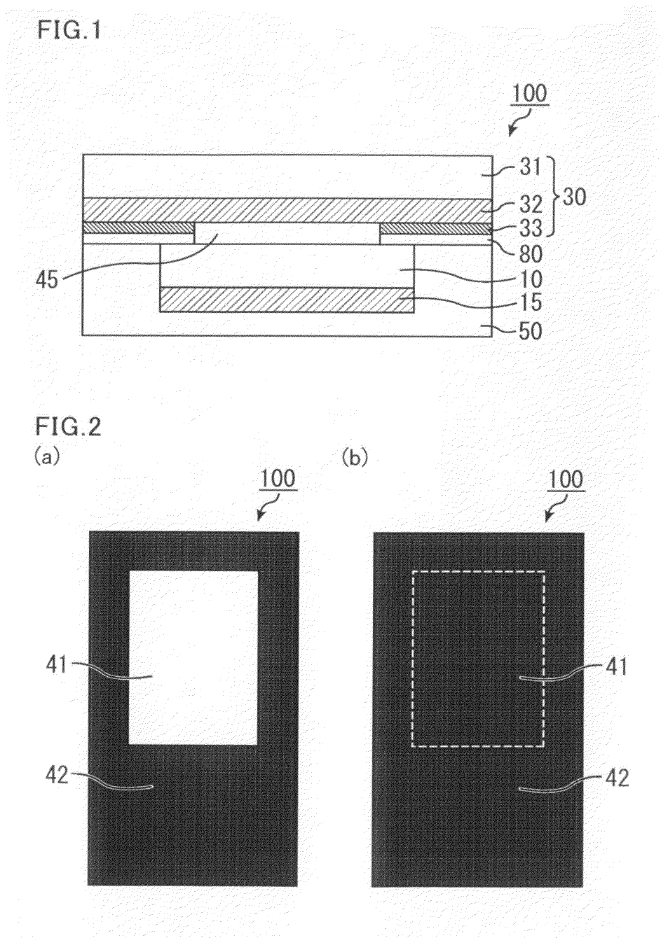

The present invention will be further explained in detail showing the embodiments below with reference to FIG. 1 to FIG. 4. However, the present invention is not limited to these embodiments. In each of the drawings used in the following explanation, items having the same structure are denoted by the same symbol so as to simplify the explanation.

### Embodiment 1

The following description will explain the structure of the display device according to the present embodiment using FIG. 1 and FIG. 2. FIG. 1 is a cross-sectional view schematically illustrating the structure of the display device according to the present embodiment. FIG. 2 is a plain view schematically illustrating the display device shown in FIG. 1, seen from a normal line direction to the surface of the substrate, and FIG. 2(a) illustrates the state when the display is on, and FIG. 2(b) illustrates the state when the display is off.

A display device 100 shown in FIG. 1 includes a liquid crystal panel 10 as a display panel, a casing 50 for housing the liquid crystal panel 10, and a protective plate 30 disposed at an observation surface side of the liquid crystal panel 10. The casing 50 and the protective plate 30 are integrally formed with an adhesive layer 80 interposed therebetween.

The liquid crystal panel 10 may be of either an active matrix type or a passive matrix type. In the present embodiment, the liquid crystal panel 10 of an active matrix type was used. A circularly polarizing plate 15 is mounted on the main surface of the liquid crystal panel 10 on the side opposite to the observation surface side. Meanwhile, no circularly polarizing plate is mounted on the main surface of the liquid crystal panel 10 on the observation surface side. The circularly polarizing plate 15 includes a λ/4 retardation plate and a polarizer sequentially in said order from the liquid crystal panel 10 side.

The protective plate 30 includes a transparent member 31 that is an acrylic resin plate having a refractive index of 1.5 and a thickness of 0.8 mm, a circularly polarizing plate 32, and a shading member 33. The main surface of the protective plate 30 on the observation surface side is formed of the transparent member 31, the surface being provided with hard coating. On the opposite surface of the transparent member 31, the circularly polarizing plate 32 is attached on the entire surface. The circularly polarizing plate 32 includes a polarizer and a λ/4 retardation plate sequentially in said order from the side of the transparent member 31.

A recessed portion is formed in the center of the casing 50, and the liquid crystal panel 10 is housed in the recessed portion. The outer wall of the casing 50 is bonded to the shading member 33 in the protective plate 30 with the adhesive layer 80 interposed therebetween. The shading member 33 is formed of a black-colored acrylic coating film having a thickness of 10 μm. An air layer 45 is provided as a light transmitting portion in the region surrounded by the shading member 33 on the observation surface side of the liquid crystal panel 10.

In the display device 100 having the aforementioned structure, when the display is off, external light coming into the protective film 30 passes through the transparent member 31 without any change and then passes through the circularly polarizing plate 32. Herein, the external light is first converted into linearly polarized light by the polarizer in the circularly polarizing plate 32. Thereafter, the linearly polarized light is converted into circularly polarized light while passing through the λ/4 retardation plate.

On one hand, the converted circularly polarized light in the region without the shading member passes through the air layer 45 without any change, and is then reflected on the surface of the liquid crystal panel 10. Upon the reflection, rotative direction of the light is reversed, and the resulting light again comes into the circularly polarizing plate 32. In the circularly polarizing plate 32, the circularly polarized light is once again converted by the λ/4 retardation plate into linearly polarized light, and is then absorbed by the polarizer.

On the other hand, the converted circularly polarized light in the region with the shading member 33 is mostly absorbed by the shading member 33. Part of the circularly polarized light reflects on the surface of the shading member 33 and again comes into the circularly polarized plate 32, and is thereafter absorbed in the circularly polarized plate 32, in the same manner as the case of the region without the shading member 33.

Observation of the state of the display device 100 according to the present embodiment when the display is on and off showed the following: When the display was on, as shown in FIG. 2(a), a display region 41 corresponding to the air layer 45 was illuminated to display images, and a non-display region 42 corresponding to the shading member 33 looked black.

In contrast, when the display was off, as shown in FIG. 2(b), the entire surface of the protective plate 30 looked integrally black with both of the display region 41 and the non-display region 42 being in almost the same black color. Therefore, the liquid crystal panel 10 was not visible. Meanwhile, the white wavy line shown in FIG. 2(b) is depicted for convenience to show the display area 31. Actually, the border between the display region 31 and the non-display region 32 are not recognizable.

Measurement of the reflectance of the light irradiating the protective plate 30 when the display was off showed that the reflectance in the display region 41 and that in the non-display region 42 were almost the same, with the reflectance in the display region being 4.18% and the reflectance in the non-display region 42 being 4.15%. Here, measurement of the reflectance of only the surface of the protective plate 30 having hard coating processed thereon showed that the surface reflectance was 4%. This indicates that reflection of the light irradiating the protective plate 30 occurred mainly on the surface of the protective plate 30, and accordingly reveals that the reflection does not occur inside the display device. Meanwhile, the reflectance was measured by receiving the light at 8° deviated from the normal line direction to the surface of the substrate of the protective plate 30 with a spectrophotometer (produced by Konica Minolta Holdings, Inc., Model No. CM2002).

In the transition from the state shown in FIG. 2(b) to the display state shown in FIG. 2(a), an image looked as if it was popping out of the integrally black protective plate 30, and thus the appearance was well-designed and excellent.

In the present embodiment as mentioned earlier, since the circularly polarizing plate 20 covers both the air layer 45 and the region surrounding it, when the display is off, external light irradiating the protective plate 30 is mostly absorbed. Accordingly, good appearance as mentioned earlier was achieved.

Moreover, since the protective plate 30 was configured to cover not only the liquid crystal panel 10 but also the entire surface of the panel-disposed side of the casing 50 as well, a flat appearance was obtained on the observation surface side of the display device 100. Further, since the protective plate 30 is colored black by a shading member 40, members disposed around the display panel such as a driver and a wiring can be kept out of sight when the display is off.

Therefore, if the display device 100 according to the present embodiment is used in the field of mobile units such as mobile phones and mobile gaming machine, stylish appearance can be achieved; while if it is used in displays for TVs and personal computers, well-designed and good appearance suitable for interior items can be achieved.

### Embodiment 2

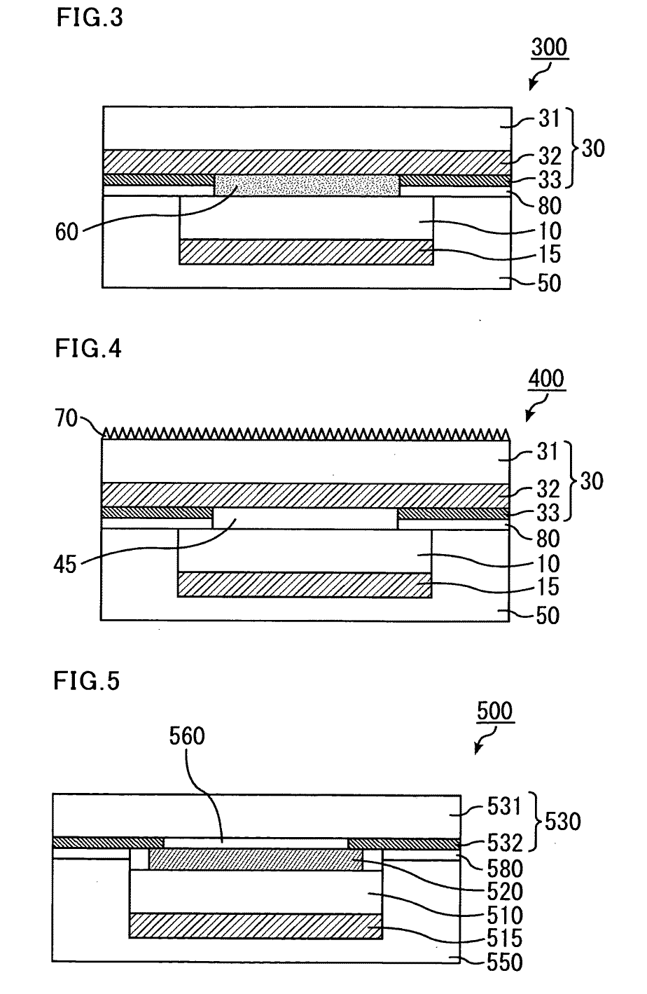

FIG. 3 is a cross-sectional view schematically illustrating the structure of a display device according to Embodiment 2 of the present invention. In the above Embodiment 1, the light-transmitting portion provided between the liquid crystal panel 10 and the protective plate 30 consists of the air layer 45 (opening in the shading member 33). In the present Embodiment, the light-transmitting portion consists of a transparent material. Namely, in FIG. 3, a display device 300 includes a filling member 60 for filling the gap between the liquid crystal panel 10 and the protective plate 30. As the filling member 60, an acrylic resin which was a transparent material was used.

The reflectance of the display device 300 having the aforementioned structure was also measured. The results showed that the reflectance of the display region 31 was 4.18%, and the reflectance of the non-display region 32 was 4.15%. Since the filling member 60 is a clear and colorless layer, displayed images were excellently visible when the display is on. Moreover, when the display was off, light scattering caused by foreign substances did not occur, and thus favorable black-colored display could be achieved.

### Embodiment 3

FIG. 4 is a cross-sectional view schematically illustrating the structure of the display device according to Embodiment 3 of the present invention. In FIG. 4, a display device 400 includes the structure of the display device 100 shown in FIG. 1, and is, further provided with an antireflection film 70 on the main surface of the protective plate 30. The antireflection film 70 is a film having a surface structure (moth-eye structure) provided with numerous nanometer-sized protrusions. The antireflection film 70 is a photocurable acrylic resin film having a thickness of 10 μm, and has 200 nm-high protrusions formed on its surface.

The display device 400 having the aforementioned structure can remarkably suppress reflections on the surface of the protective plate 30 with the antireflection film 70. Therefore, the display quality is high when the display is on.

The reflectance of the display region and the non-display region when the display was off were measured. The results showed that the reflectance of the display region was 0.24%, and the reflectance of the non-display region was 0.20%. As shown by the results, the reflectance of the display region and that of the non-display region are almost equal to one another. For this reason, when the display is off, the entire surface of the protective plate 30 looked integrally black with both of the display region and the non-display region being in almost the same black color. Therefore, the region where the liquid crystal panel 10 is disposed is hardly visible so that the display device 400 with good appearance can be obtained.

The present Embodiment may have a structure in which the filling material 60 is provided in place of the air layer 45 as shown in Embodiment 2.

The circularly polarized plate 32 is provided on the entire surface of the protective plate 30 in Embodiments 1 to 3; however, the present invention is not limited to the examples. A part of the protective plate 30 may have a region where the circularly polarizing plate 32 is not provided.

The display devices 100, 300, and 400 according to the respective Embodiments may include an organic EL panel, PDP, or FEDP in place of the liquid crystal panel 10. Namely, the display device 100 may be an organic EL display, a PDP display, or an FEDP display.

### Comparative Embodiment

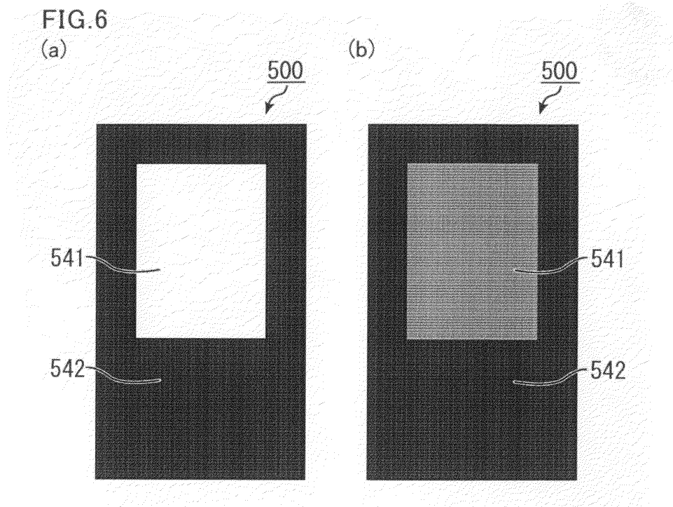

A display device according to comparative embodiment of the present invention will be described below using FIG. 5 and FIG. 6. FIG. 5 is a cross-sectional view schematically illustrating the structure of the display device according to the comparative embodiment of the present invention. FIG. 6 is a plain view schematically illustrating the display device shown in FIG. 5, seen from a normal line direction to the surface of the substrate. FIG. 6(a) illustrates the state when the display is on, and FIG. 6(b) illustrates the state when the display is off.

A display device 500 shown in FIG. 5 includes a liquid crystal panel 510, a casing 550 for housing the liquid crystal panel 510, and a protective plate 530 disposed at an observation surface side of the liquid crystal panel 510. The casing 550 and the protective plate 530 are integrally formed with an adhesive layer 580 interposed therebetween.

The liquid crystal panel 510 has a similar structure as that of the liquid crystal panel 10; however, a circularly polarizing plate 520 is mounted on the observation surface side and a circularly polarizing plate 515 is mounted on the main surface on the side opposite to the observation surface. The circularly polarizing plate 515 includes a λ/4 retardation plate and a polarizer sequentially in said order from the side of the liquid crystal panel 510. The circularly polarizing plate 520 includes a polarizer and a λ/4 retardation plate sequentially in said order from the protective plate 530 side.

A recessed portion is formed in the center of the casing 550, and the liquid crystal panel 510 is housed in the recessed portion.

The protective plate 530 includes a transparent acrylic resin plate 531 having a refractive index of 1.5 and a thickness of 0.8 mm with its surface treated with hard coating and also includes a shading member 532 which is a black-colored acrylic resin plate having a thickness of 10 μm. The shading member 532 is disposed at an area surrounding an air layer 560 as a light-transmitting portion provided on the observation surface side of the liquid crystal panel 510.

In the display device 500 having the aforementioned configuration, a part of external light coming into the protective plate 530 passes through the air layer 560, and is then converted into linearly polarized light by a polarizer included in the circularly polarizing plate 520. Thereafter, while passing through the λ/4 retardation plate, the linearly polarized light is converted into circularly polarized light. The converted circularly polarized light is reflected on the surface of the liquid crystal panel 510. Upon the reflection, rotative direction of the light is reversed, and the resulting light again comes into the λ/4 retardation plate so that most of the light is absorbed by the polarizer.

Meanwhile, in the region where the shading member 532 is provided, light is mostly absorbed by the shading member 532 and is partly reflected on the surface of the shading member 532 and then goes outside. Moreover, in the vicinity of the border between the shading member 532 and the air layer 560, a part of the light irradiating the shading member 532 is reflected and goes outside.

For this reason, seen from the display device 500 in a normal line direction to the side of the substrate, when the display is on, the display region 541 corresponding to the air layer 560 is illuminated to display images and the non-display region 542 corresponding to the shading member 532 looks black as shown in FIG. 6(a). When the display is off, the display region 541 looks like a grayish color due to the reflection of the light that has irradiated the shading member 532 as shown in FIG. 6(b), and the liquid crystal panel 510 is quite visible.

Measurement of the reflectance of the protective plate 530 when the display was off showed that the reflectance of the display region 541 was 8.2%, and the reflectance of the non-display region 542 was 6.5%. Measurement of the reflectance of only the surface of the protective plate 530 treated with hard coating showed that the surface reflectance was 4%. This indicates that, in the comparative Embodiment, reflection occurs inside the display device in addition to the reflection on the surface of the protective plate 530, and the reflected light goes outside.

The present application claims priority to Patent Application No. 2009-031599 filed in Japan on Feb. 13, 2009, under the Paris Convention and provisions of national law in a designated State. The entire contents of which are hereby incorporated by reference.

### EXPLANATION OF SYMBOLS

10, 510 Liquid crystal panel
15, 32, 515, 532 Circularly polarizing plate
30, 530 Protective plate
31 Transparent member
33, 532 Shading member
41, 541 Display region
42, 542 Non-display region
45, 560 Air layer
50, 550 Casing
60 Filling member
70 Antireflection film
80, 580 Adhesive layer
100, 300, 400, 500 Display device
531 Transparent acrylic resin plate

1. A display device, comprising:
a display panel; and
a protective plate disposed at an observation surface side of the display panel,
wherein the display device further comprises a light-transmitting portion at an observation surface side of the display panel, and
the protective plate includes, when observed from a normal line direction of its main surface, a circularly polarizing plate which covers both of the light-transmitting portion and a region around the light-transmitting portion.

2. The display device according to claim 1,
wherein, in the protective plate, the reflectance of external light at a surface corresponding to the light-transmitting portion and the reflectance of external light at a surface corresponding to the region around the light-transmitting portion are substantially equal to one another when observed from a normal line direction of the main surface of the protective plate.

3. The display device according to claim 1,
wherein the protective plate includes a transparent member, and
the display device further comprises a shading member in the region around the light-transmitting portion.

4. The display panel according to claim 1,
wherein a gap between the display panel and the protective plate is filled with a resin.

5. The display panel according to claim 1,
wherein the protective plate further comprises an antireflection film having a nano structure formed thereon on a main surface of the protective plate on the side opposite to the side where the display panel is disposed.

6. The display device according to claim 1,
wherein the display panel is a liquid crystal panel.

7. The display device according to claim 1,
wherein the display panel is an organic electroluminescent display panel.
